(19) United States
(12) Patent Application Publication
(10) Pub. No.: US 2021/0339223 A1
(43) Pub. Date: Nov. 4, 2021

(54) COMPOSITE HYDROGELS FOR ADSORPTION OF ORGANIC ACID ANIONS & METAL IONS FROM LEAN MDEA

(71) Applicants: KHALIFA UNIVERSITY OF SCIENCE AND TECHNOLOGY, Abu Dhabi (AE); ABU DHABI NATIONAL OIL COMPANY, Abu Dhabi (AE)

(72) Inventors: Fawzi BANAT, Abu Dhabi (AE); Priyabrata PAL, Abu Dhabi (AE); Anjali Achazhiyath EDATHIL, Abu Dhabi (AE)

(21) Appl. No.: 17/271,563

(22) PCT Filed: Aug. 27, 2018
(86) PCT No.: PCT/IB2018/056479

§ 371 Date: Feb. 25, 2021

(51) Int. Cl. B01J 20/26; B01J 20/24; B01J 20/10; B01J 20/20; B01J 20/28; B01D 53/14

(52) U.S. Cl. CPC B01J 20/261; B01J 20/24; B01J 20/103; B01J 20/20; B01J 20/28047; B01D 2252/20426; B01D 53/1468; B01D 53/1475; B01D 53/1493; B01D 2252/20484; B01D 2252/20405; B01D 53/1425

(57) ABSTRACT

Various hydrogels are described which are useful for the regeneration of methyldiethanolamine which is used to scrub H₂S/CO₂. Methods of regenerating methyldiethanolamine using such hydrogels are also described.

The present invention relates to gas sweetening in natural gas processing plant, and in particular to the regeneration of methyldiethanolamine which is used to scrub H₂S/CO₂.

### BACKGROUND

Natural gas sweetening using aqueous Methyldiethanolamine (MDEA, 45-50 weight %) is currently used by e.g. ADNOC Gas Processing Company (Habshan, Abu Dhabi) to scrub H₂S/CO₂. The rich MDEA solution is fed to a regeneration column where heat is applied to strip the acid gas components to get back the lean MDEA solution. In this absorption process, formates, acetates, propionates etc. as organic acid anions are formed by the reaction between aerial oxygen and H₂S and CO₂. The reactions between these anionic species and protonated MDEA form heat stable salt (HSS), which cannot be removed from the solvent by heating in the regenerator. Continuous accumulation of these HSS in the MDEA solvent deteriorates its quality to lower its absorption capacity. The major components of HSS are Total Organic Acid (TOA) anions, mainly acetate, formate, propionate, glycolate, valerate etc. Another serious concern of the unit are the other major contaminants like heavy metal ions, arising mostly from corrosion and erosion of process equipment and accumulating in the lean MDEA solvent. Some heavy metal ions might come from the demineralized water added as make-up water to maintain the concentration of lean MDEA solution from time to time. Therefore, regeneration of MDEA is inevitable for the industry.

The conventional methods for removal of total contaminants from lean MDEA have been preceded by using ion exchange resins, separation membranes, etc. It has been proposed to remove heat stable salts from lean alkanolamine solution by ion exchange resins. U.S. Pat. Nos. 2,797,188, 4,122,149, 4,170,628, 4,477,419, 4,758,311, 4,795,565, 4,970,344, 4,999,113, 5,006,258, 5,162,084, 5,277,822 and 5,788,864 described the removal of heat stable salt anions by exchange with hydroxide from an anion exchange resins and cations, such as sodium and potassium, by hydrogen ion from a cation exchange resins. However, in case of the removal using ion exchange resin or separation membrane, it is difficult and expensive to treat the lean MDEA containing a lot of heat stable salt anions and heavy metal ions as contaminant. Though, removal of heavy metal ions like chromium or iron were not described anywhere except Patent Application No. PCT/IB2015/059664. Some particular background art is discussed hereinafter.

U.S. Pat. No. 5,385,741 RINN, Jean-Charles; ROBILLARD, Bertrand “Calcium alginate gel partially deficient in calcium ions for use in binding metal cations” (“RINN”). Rinn et al. discloses an ionically gellable material which is gelled with a metal cation ion. The gel is purposefully formed as deficient of metal cation content. Binding sites of the gel are thus not occupied by the metal cation so the gel can be used to bind and remove metal cations from solution. In a preferred embodiment a calcium alginate gel in the form of beads is prepared, with the calcium ion content being reduced to between 0.01 mg/g and 1.5 mg/g of moist gel by contacting the gel with an aqueous solution of acid such as lactic acid or tartaric acid having a pH of 1 to 3.5.

U.S. Patent Application No. 2016/0193560 LEISTER, Jonathan W.; GUGAS, Ross E. “Optimization of stripper feed configuration for rich/lean solvent regeneration” (“LEISTER”). Leister et al. teaches an improved process for regenerating solvent used to remove contaminants from a fluid stream. The disclosure focusses on a solvent regeneration system which comprises a rich/lean solvent stripper column, reboiler, condenser and reflux receiver. The disclosure goes on to discuss specifically amine based solvents, used to remove acid gas in the gas sweetening process. A discussed method for regenerating the amine based solvent is the application of heat.

Chinese Patent Application No. 105504166, HONGLIAN, Dai; HAIFEI, Kang; WENYING, Wei; YANZENG, Wu “Sodium alginate-acrylamide composite aquagel, and preparation method and application thereof” (“HONGLIAN”). Honglian et al. teaches of a sodium alginate-acrylamide composite aquagel. The disclosure goes on to discuss a preparation method for the aquagel. The application additionally teaches that the composite aquagel has favourable multivalent ion adsorption capacity and biocompatibility. Further the disclosure teaches that the prepared [sodium] alginate-acrylamide composite hydrogel can be used as an adsorbent for heavy metal ions and particularly for adsorption separation of copper, mercury, cadmium, lead, zinc, ions, barium ions, chromium ions, manganese, cobalt, nickel and tungsten ions.

“Application of anionic acrylamide-based hydrogels in the removal of heavy metals from waste water”; ATTA, Ayman M.; ISMAIL, Husain S.; ELSAAED, Ashraf M., Egyptian Petroleum Research Institute, (Wiley online library 2011) (“ATTA”). Atta et al. teaches of the removal of heavy metal ions from waste waters and from natural waters. The disclosure goes on to discuss metal ion chelation polymers, called polychelatogens which contain one or more electron donor atoms, such as N, S, O and P which can form coordinate bonds with most of the toxic heavy metals. The disclosure goes on to state that hydrogels containing amide, amine, carboxylic acid, hydroxyl, and ammonium groups can bind metal ions and be good polychelatogens for water purification applications.

“A free-standing calcium alginate/polyacrylamide hydrogel nanofiltration membrane with high anti-fouling performance: preparation and characterization”; ZHANG, Xinxin; LIN, Beibei, ZHAO, Kongyin; WEI, Junfu; GUO, Jie; CUI, Wenkui; JIANG, Shuai; LIU Dong; LI, Jianxin, Desalination, volume 365, 1 Jun. 2015, pages 234-241. (“ZHANG”). Zhang et. al teaches of a an anti-fouling, free-standing membrane synthesised through polymerization of acrylamide in the presence of sodium alginate using N,N′-methylene-bisacrylamide as the covalent cross-liker and CaCl₂) as the ionic cross-linker. The disclosure goes on to discuss that anti-fouling performance of the hydrogel filtration membrane was tested.

“Calcium alginate hydrogel filtration membrane with excellent anti-fouling property and controlled separation performance” ZHAO, Kongyin; ZHANG, Xinxin; WEI, JUNFU; Li, JAIME; ZHOU, Xiangyu; LIU Dong; LIU, Zhibo L I, Jianxin; Journal of Membrane Science, volume 492, 15 Oct. 2015, pages 536-546. (“ZHAO”). Zhao et. al teaches of a calcium alginate hydrogel filtration membrane being prepared using polyethylene glycol (PEG) as the pore-forming agent. The disclosure discusses that the mechanical behaviour of the membrane was also evaluated. The disclosure goes on to discuss that the concentrations of sodium alginate and PEG on the pure water flux and pure filtration properties of lysozyme solutions were investigated.

Despite the foregoing developments, there is still room for improvement in the art. For example, there is a need for adsorbents with a more effective composite hydrogel to remove the TOA anions and the metals ions contaminants so to regenerate lean MDEA.

### SUMMARY OF THE INVENTION

It is an object of the present invention to provide an adsorbent which allows easily, effectively and substantially totally removing organic acid anions and heavy metal ions from an MDEA solution like aqueous MDEA.

It is another object of the present invention that the inventive adsorbent can be prepared in a simple, reliable and efficient manner.

It is another object of the present invention to provide a method which allows easily, effectively and substantially totally removing organic acid anions and heavy metal ions from an MDEA solution like aqueous MDEA.

In order to achieve one or more of the mentioned objects, the present invention provides a calcium alginate-polyacrylamide-X composite hydrogel, wherein X is selected from one of the following compounds: silica, polyaniline-silica, graphene oxide, and reduced graphene oxide. Accordingly, the present invention provides one composite hydrogel wherein X is silica, one composite hydrogel wherein X is polyaniline-silica, one composite hydrogel wherein X is graphene oxide, and one composite hydrogel wherein X is reduced graphene oxide. The composite hydrogel according to the present invention is preferably prepared by solution polymerization.

In order to achieve one or more of the mentioned objects, the present invention further provides a method for regenerating a methyldiethanolamine solution in which a methyldiethanolamine solution is passed through a hydrogel according to the present invention. Preferably, in the method according to the present invention organic acid anions and/or heavy metal ions are removed from the methyldiethanolamine solution, especially heavy metal ions like chromium and/or iron. It is especially preferred that the regenerated methyldiethanolamine is previously used to scrub H₂S/CO₂.

### BRIEF DESCRIPTION OF THE DRAWINGS

The present invention will be described with reference to the accompanying drawings which show:

FIG. 1: Calcium alginate-polyacrylamide (Alg-Aam) composite hydrogel

FIG. 2: Calcium alginate-polyacrylamide-silica (Alg-Aam-SI) composite hydrogel

FIG. 3: Calcium alginate-polyacrylamide-polyaniline_silica (Alg-Aam-PA_SI) composite hydrogel

FIG. 4: Calcium alginate-polyacrylamide-graphene oxide (Alg-Aam-GO) composite hydrogel

FIG. 5: Calcium alginate-polyacrylamide-thermally reduced graphene oxide (Alg-Aam-TRGO) composite hydrogel

FIG. 6: % Removal of chromium at three different temperatures using varying amount of Alg-Aam

FIG. 7: % Removal of iron at three different temperatures using varying amount of Alg-Aam

FIG. 8: % Removal of TOA anions at three different temperatures using varying amount of Alg-Aam

FIG. 9: % Removal of chromium at three different temperatures using varying amount of Alg-Aam-SI

FIG. 10: % Removal of iron at three different temperatures using varying amount of Alg-Aam-SI

FIG. 11: % Removal of TOA anions at three different temperatures using varying amount of Alg-Aam-SI

FIG. 12: % Removal of chromium at three different temperatures using varying amount of Alg-Aam-PA_SI

FIG. 13: % Removal of iron at three different temperatures using varying amount of Alg-Aam-PA_SI

FIG. 14: % Removal of TOA anions at three different temperatures using varying amount of Alg-Aam-PA_SI

FIG. 15: % Removal of chromium at three different temperatures using varying amount of Alg-Aam-GO

FIG. 16: % Removal of iron at three different temperatures using varying amount of Alg-Aam-GO

FIG. 17: % Removal of TOA anions at three different temperatures using varying amount of Alg-Aam-GO

FIG. 18: % Removal of chromium at three different temperatures using varying amount of Alg-Aam-TRGO

FIG. 19: % Removal of iron at three different temperatures using varying amount of Alg-Aam-TRGO

FIG. 20: % Removal of TOA anions at three different temperatures using varying amount of Alg-Aam-TRGO

FIG. 21: Removal of TOA anions using 0.5 gm adsorbents at three different temperatures

FIG. 22: Removal of TOA anions using 3.0 gm adsorbents at three different temperatures

FIG. 23: Removal of chromium using 0.5 gm adsorbents at three different temperatures

FIG. 24: Removal of chromium using 0.5 gm adsorbents at three different temperatures

FIG. 25: Removal of iron using 0.5 gm adsorbents at three different temperatures

FIG. 26: Removal of iron using 3.0 gm adsorbents at three different temperatures

### DETAILED DESCRIPTION OF THE INVENTION

Aqueous methyldiethanolamine (MDEA) is used in natural gas processing plant to scrub H₂S/CO₂. A ‘Rich’ MDEA solution refers to an MDEA solution which has become saturated with H₂S/CO₂ and can no longer perform the required scrubbing action. When this occurs the MDEA must be regenerated to a ‘lean’ solution. This lean solution refers to MDEA free of any acid components and capable of absorbing the H₂S and CO₂. Commonly heat is used to regenerate the MDEA, but there are instances when heat stable salts (HSS) are formed which cannot be removed by the application of heat. The HSS forms when organic acid anions react with a protonated MDEA solution. Major components of HSS include total organic acid (TOA) anions such as acetate and formate. Lean MDEA also contains other contaminants such as heavy metal ions.

Technically, the composite hydrogel adsorbent is capable of removing organic acid anions and heavy metal ions. Therefore, lean MDEA can be purified and free of any anions and metal ions after adsorption. Thus, absorption efficiency of purified MDEA will be better and hence loss of MDEA due to foaming will be reduced. The requirement of fresh MDEA will be causing less operational cost. The purified MDEA will effectively reduce the instrument cost causing less capital cost.

The invention also provides a method of treating lean MDEA for removal of Total Organic Acid (TOA) anions and heavy metal ions (mostly chromium and iron) which comprises contacting contaminated lean MDEA with Alg-Aam composite hydrogel used as adsorbent, prepared by a process comprising adding a mixed solution of sodium alginate (1 wt %) and acrylamide (10 wt %), APS and saturated BIS solutions. The homogeneous solution was transferred into a straw and kept for polyacrylamide hydrogel formation at 80° C. for 3 hrs. The sodium alginate-polyacrylamide hydrogel was cooled at room temperature and immersed in 1M CaCl₂) solution and kept overnight for polymerizing to get calcium alginate-polyacrylamide (Alg-Aam) composite hydrogel, used as adsorbent.

The invention also provides a method of treating lean MDEA for removal of Total Organic Acid (TOA) and heavy metal ions (mostly chromium and iron) which comprises contacting contaminated lean MDEA with Alg-Aam-SI composite hydrogel used as adsorbent, prepared by a process comprising adding a mixed solution of sodium alginate (1 wt %), acrylamide (10 wt %), silica (1 wt %), APS and saturated BIS solutions. The homogeneous solution was transferred into a straw and kept for polyacrylamide hydrogel formation at 80° C. for 3 hrs. The sodium alginate-polyacrylamide-silica composite cooled at room temperature and immersed in 1M CaCl₂) solution and kept overnight for polymerizing to get calcium alginate-polyacrylamide-silica (Alg-Aam-SI) composite hydrogel, used as adsorbent.

The invention further provides a method of treating lean MDEA for removal of Total Organic Acid (TOA) and heavy metal ions (mostly chromium and iron) which comprises contacting contaminated lean MDEA with Alg-Aam-PA_SI adsorbent prepared by a process comprising adding a mixed solution of sodium alginate (1 wt %), acrylamide (10 wt %), polyaniline-silica (1 wt %), APS and saturated BIS solutions. The homogeneous solution was transferred into a straw and kept for polyacrylamide hydrogel formation at 80° C. for 3 hrs. The sodium alginate-polyacrylamide-polyaniline-silica composite cooled at room temperature and immersed in 1M CaCl₂) solution and kept overnight for polymerizing to get calcium alginate-polyacrylamide-polyaniline-silica (Alg-Aam-PA_SI) composite hydrogel, used as adsorbent.

Further provided is a method of treating lean MDEA for removal of Total Organic Acid (TOA) and heavy metal ions (mostly chromium and iron) which comprises contacting contaminated lean MDEA with Alg-Aam-GO adsorbent prepared by a process comprising adding a mixed solution containing graphene oxide (GO) in sodium alginate (1 wt %) and acrylamide (10 wt %), APS and saturated BIS solutions. The homogeneous solution was transferred into a straw and kept for polyacrylamide hydrogel formation at 80° C. for 3 hrs. The sodium alginate-polyacrylamide-GO composite cooled at room temperature and immersed in 1M CaCl₂) solution and kept overnight for polymerizing to get calcium alginate-polyacrylamide-graphene oxide (Alg-Aam-GO) composite hydrogel, used as adsorbent.

Additionally provided is a method of treating lean MDEA for removal of Total Organic Acid (TOA) and heavy metal ions (mostly chromium and iron) which comprises contacting contaminated lean MDEA with Alg-Aam-TRGO adsorbent prepared by a process comprising adding a mixed solution containing thermally reduced graphene oxide (TRGO) in sodium alginate (1 wt %) and acrylamide (10 wt %), APS and saturated BIS solutions. The homogeneous solution was transferred into a straw and kept for polyacrylamide hydrogel formation at 80° C. for 3 hrs. The sodium alginate-polyacrylamide-TRGO composite cooled at room temperature and immersed in 1M CaCl₂) solution and kept overnight for polymerizing to get calcium alginate-polyacrylamide-graphene oxide (Alg-Aam-TRGO) composite hydrogel, used as adsorbent.

It is preferable that in the above described methods of treating lean MDEA for purification said alginate is sodium alginate salt.

It is further preferable that in the above described methods of treating lean MDEA for removal of total organic acid anions and heavy metal ions the contaminated lean MDEA contains those contaminants and that said mixed solution contains an adsorbent for adsorbing materials.

Different types of organic as well as inorganic species are found to be present as contaminants in lean MDEA solvent. Heat stable salt anions (mainly organic acid anions, e.g., acetate, formate, propionate, glycolate, valerate etc.) are present in high amount in lean MDEA and detected using UV-VIS spectrophotometer as TOA anions. The total organic acid content was found to be 3670 ppm (using Test kit 365, UV-VIS Spectrophotometer, Hach Lange) in one of the batch of lean MDEA from ADNOC Gas Processing Company (Habshan, Abu Dhabi). The major metal ions were determined using Inductively Coupled Plasma Optical Emission Spectrometry (ICP-OES) and were found to be chromium (925.3 ppb) and iron (1114 ppb), respectively. Lean MDEA samples were collected time to time from the ADNOC Gas Processing Company (Habshan, Abu Dhabi) and were analyzed with different concentrations of total organic acid anions and heavy metal ions (chromium and iron) content.

Five different types of composite hydrogels, namely calcium alginate-polyacrylamide hydrogel composite (Alg-Aam), calcium alginate-polyacrylamide-silica composite (Alg-Aam-SI), calcium alginate-polyacrylamide-polyaniline_silica composite (Alg-Aam-PA_SI), alginate-acrylamide-graphene oxide (Alg-Aam-GO) and alginate-acrylamide-thermally reduced graphene oxide (Alg-Aam-TRGO) were prepared and used as batch adsorption studies to monitor the removal of these contaminants from lean MDEA solvents. Using equilibrium batch adsorption studies, maximum total organic acid (TOA) anions removal was found to be 31.06% for Alg-Aam, 33.11% for Alg-aam-SI, 28.75% for Alg-Aam-PA_SI, 23.57% for Alg-Aam-GO, and 28.75% for Alg-Aam-TRGO using 3.0 gm adsorbent at 53° C. Similarly, maximum % chromium (iron) removal was found to be 66.42% (73.19%) for Alg-Aam, 65.38% (80.80%) for Alg-aam-SI, 67.56% (79.99%) for Alg-Aam-PA_SI, 62.91% (69.15%) for Alg-Aam-GO, and 65.44% (67.42%) for Alg-Aam-TRGO using 3.0 gm adsorbent at 53° C.

### Example 1

Preparation of Calcium Alginate-Polyacrylamide (Alg-Aam) Composite Hydrogel:

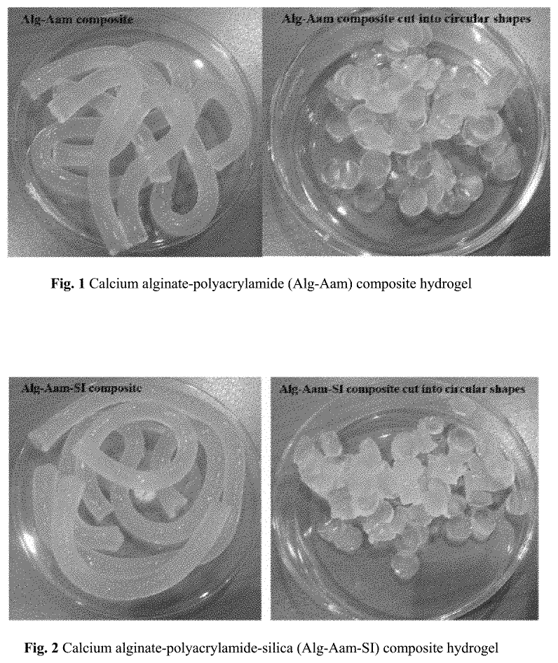

Hydrogels were prepared by solution polymerization with initial solutions consisting of monomers (sodium alginate & acrylamide), cross linker (N,N′-Methylenebisacrylamide, named as BIS) and initiator (ammonium persulfate, APS). Firstly, sodium alginate (1 wt %) and acrylamide (10 wt %) were added and dissolved in deionized water under magnetic stirring for overnight at room temperature. Successively, to 6.0 mL of alginate-acrylamide mixture, 300 μL APS solution (5.0 wt %) and 150 μL saturated BIS solutions were added and the solution was allowed to homogenize by mechanical stirring for 5 minutes. The homogeneous solution was transferred into a straw and kept for hydrogel formation at 80° C. for 3 hrs. After the hydrogel is formed, the alginate-polyacrylamide composite obtained in its cylindrical form was cooled to room temperature. The composites were taken out of the straw and immersed in 1M CaCl₂) solution and kept overnight for polymerizing the alginate to produce calcium alginate-polyacrylamide (Alg-Aam) composite hydrogel. Finally, the hydrogels were washed continuously with deionized water to ensure the removal of unreacted monomers and cut into circular shapes (FIG. 1).

### Example 2

Preparation of Calcium Alginate-Polyacrylamide-Silica (Alg-Aam-SI) Composite Hydrogel:

Hydrogels were prepared by solution polymerization with same initial solutions consisting of monomers (sodium alginate & acrylamide), silica particles, cross linker (BIS) and initiator (APS). Firstly, sodium algiante (1 wt %), acrylamide (10 wt %) and silica particles (SI, 1 wt %) were added to deionized water and allowed to homogenize under magnetic stirring for overnight at room temperature.

Successively to 6.0 mL of sodium alginate-acrylamide-SI mixture, 300 μL APS solution (5.0 wt %) and 150 μL saturated BIS solutions were added and the solution was allowed to homogenize by mechanical stirring for 5 minutes. The homogeneous solution was transferred into a straw and kept for polyacrylamide hydrogel formation at 80° C. for 3 hrs.

After the formation of polyacrylamide hydrogel, the sodium alginate-polyacrylamide-SI composite obtained in its cylindrical form was cooled to room temperature. Then, the composites were taken out of the straw and immersed in 1M CaCl₂) solution and kept overnight for polymerizing the alginate. Finally, the calcium alginate-polyacrylamide-silica (Alg-Aam-SI) composite hydrogels were washed continuously with deionized water to ensure the removal of unreacted monomers and cut into circular shapes (FIG. 2).

### Example 3

Preparation of Calcium Alginate-Polyacrylamide-Polyaniline-Silica (Alg-Aam-PA_SI) Composite Hydrogel:

Firstly, silica gels of particle size 1-3 mm were activated by preheating at 85° C. for 3 hrs. 10.0 g of dried silica gel were initially dispersed in deionized water on a magnetic stirrer for 2 hrs. 0.2 g aniline was dissolved in 15 mL hydrochloric acid and was added to silica gel suspension at 0-4° C. for 2 hrs. under magnetic stirring. After 2 hrs., 0.3 g of APS was dissolved in 75 mL of water and added to the mixture at 0-4° C. and stirring was continued for 2 hrs. The solution was then kept in fridge at 0-4° C. for overnight to ensure complete polymerization to produce PA_SI. The samples were then filtered and washed several times with water to remove unreacted monomers. Finally, samples were dried at 85° C. overnight and used for further preparation of calcium alginate-polyacrylamide-polyaniline-silica (Alg-Aam-PA_SI) composite hydrogel.

Same as previous hydrogel synthesis, sodium algiante (1 wt %), acrylamide (10 wt %) and PA_SI compostes (1 wt %) were added to deionized water and allowed to homogenize under magnetic stirring for overnight at room temperature. Successively to 6.0 mL of sodium alginate-acrylamide-PA_SI mixture, 300 μL APS solution (5.0 wt %) and 150 μL saturated BIS solutions were added and the solution was allowed to homogenize by mechanical stirring for 5 minutes. The so obtained homogeneous solution was transferred into a straw and kept for polyacrylamide-PA_SI hydrogel formation at 80° C. for 3 hours.

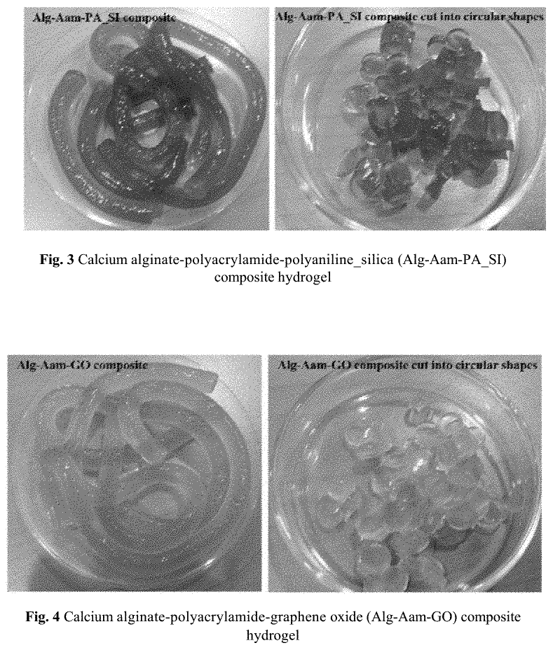

After the hydrogel formation, the sodium alginate-polyacrylamide-PA_SI composite obtained in its cylindrical form was cooled to room temperature. Then, the composites were taken out of the straw and immersed in 1M CaCl₂) solution and kept overnight for polymerizing to produce calcium alginate-polyacrylamide-PA_SI (Alg-Aam-PA_SI) composite hydrogel. Finally, the hydrogels were washed continuously with deionized water to ensure the removal of unreacted monomers and cut into circular shapes (FIG. 3).

### Example 4

Preparation of Alginate-Acrylamide-Graphene Oxide/Thermally Reduced Graphene Composite:

Dried GO/TRGO (0.015 wt %) was dispersed in desired amount of distilled water by sonication for 30 minutes and followed by vigorous mechanical stirring for 10 minutes. This process of sonication and mechanical mixing was continued for 2 hrs. After achieving full dispersion of GO/TRGO in water, sodium alginate (1 wt %) and acrylamide (10 wt %) were added and allowed to dissolve under magnetic stirring overnight at room temperature.

To 6 mL of sodium alginate-acrylamide-GO mixture solutions, 300 μL APS solution (5.0 wt %) and 150 μL saturated BIS solutions were added and the solution was allowed to homogenize by mechanical stirring for 5 minutes. The homogeneous solution was then transferred into a straw and kept for polyacrylamide-GO hydrogel formation at 80° C. for 3 hrs.

After the polyacrylamide-GO hydrogel formation, the sodium alginate-polyacrylamide-GO composite obtained in its cylindrical form was cooled to room temperature. Then, the composites were taken out of the straw and immersed in 1M CaCl₂) solution and kept overnight for polymerizing the alginate to produce calcium alginate-polyacrylamide-GO (Alg-Aam-GO) composite hydrogel. Finally, the hydrogels were washed continuously with DI water to ensure the removal of unreacted monomers. Similar process of synthesis was used for preparing Alg-Aam-TRGO composite using TRGO instead of GO (FIG. 4 and FIG. 5).

### EXPERIMENTAL

In the present work, bio-polymeric adsorbent calcium alginate and other synthetic polymer (polyacrylamide, polyaniline) were prepared and particles like silica, graphene oxide and thermally reduced graphene oxides were used to prepare five types of composite hydrogels (namely, Alg-Aam, Alg-Aam-SI, Alg-Aam-PA_SI, Alg-Aam-GO and Alg-Aam-TRGO) to remove organic acid anions and heavy metal ions present in lean MDEA solutions. The batch adsorption studies for the removal of both total organic acid anions as HSS anions and heavy metal ions like iron and chromium at varying temperatures (23° C.-53° C.) were investigated.

Materials

Alginic acid sodium salt (Na-Alg) of 91% food grade (from Loba Chemie Pvt. Ltd, India) with minimum viscosity of 45 centipoises (cps) for 1.0% w/v solution and calcium chloride dihydrate (from Merck KGaA, Germany) were of analytical grade and used without further purification. Acrylamide (Aam), N,N′-methylenebisacrylamide (BIS) and ammonium peroxodisulfate (APS) were purchased from Loba Chemie, India. All other chemicals used in this study were purchased from Sigma Chemical Co., USA. Lean MDEA solvents containing 50 wt % methyldiethanolamine (MDEA) was used for the batch adsorption experiments and was obtained from ADNOC Gas Processing Company (Habshan, Abu Dhabi). Deionized water (DI water) was used to carry out all the experiments.

Instrumentation

The concentration of total organic acid anions in the lean MDEA solution was determined using UV-VIS Spectrophotometer (DR5000, Hach Lange; Test kit 365). Inductively coupled plasma optical emission spectroscopy (ICP-OES, Optima 8000; Perkin Elmer) was used for the elemental analysis of metal ions.

Batch Adsorption Studies

The % removal of total organic acid anions and heavy metal ions were studied from batch adsorption experiments using mixed batch reactor technique. Varying amount of beads (0.5 to 3.0 gm) were added into 10 mL lean MDEA solution taken in 150 mL conical flask and allowed to equilibrate in a water bath shaker (Dihan, Kora) at 160 rpm at different temperatures ranging from 23° C.-53° C. for 4 hrs.

### RESULTS and DISCUSSIONS

Analysis of Total Organic Acid Anions (HSS) and Heavy Metal Ions

The total organic acid content using Test kit 365 from Hach Lange was found to be 3670 ppm. The total amount of organic acid content measured using UV-VIS spectrophotometer gave almost same results as measured using Ion-chromatograph technique (Patent Application No. PCT/IB2015/059664). The major metal ions were determined using ICP-OES and found to be chromium (925.3 ppb) and iron (1114 ppb), respectively.

Removal of chromium, iron and total organic acid anions using different composite hydrogel

A. Using Alg-Aam Composite Hydrogel

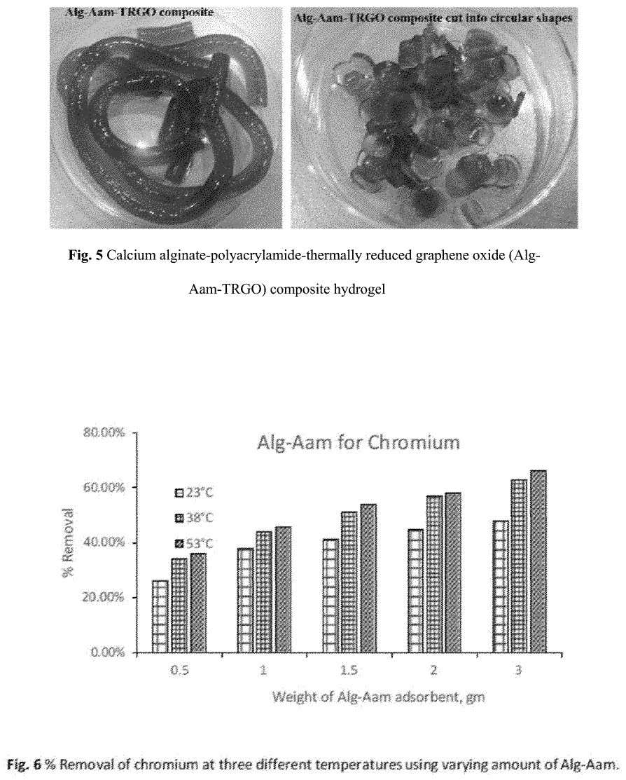

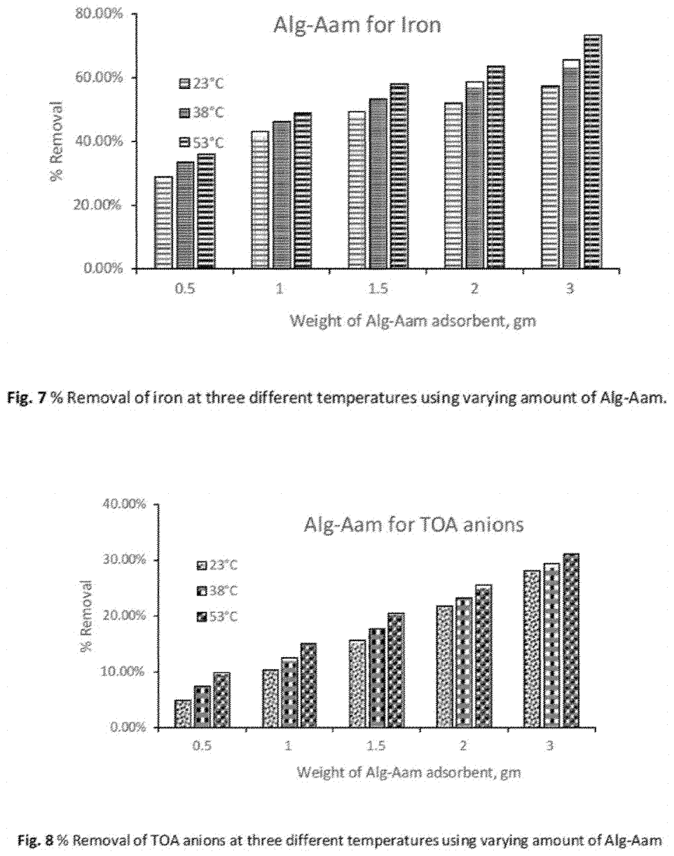

The % removal of chromium, iron and total organic acid anions using Alg-Aam composite hydrogel for five different weights are shown in Table 1 and FIG. 6-8.

TABLE 1
% Removal of chromium, iron and TOA anions at three different temperatures
using varying amount of Alg-Aam composite hydrogel.

| | | % Removal of Chromium | | | % Removal of Iron | | | % Removal of TOA anions | | |
|---|---|---|---|---|---|---|---|---|---|---|
| Adsorbent | Wt., gm | 23° C. | 38° C. | 53° C. | 23° C. | 38° C. | 53° C. | 23° C. | 38° C. | 53° C. |
| Alg-Aam | 0.5 | 26.12 | 34.31 | 36.11 | 28.88 | 33.55 | 35.79 | 4.90 | 7.36 | 9.81 |
| | 1 | 37.89 | 43.95 | 45.79 | 43.03 | 46.12 | 48.82 | 10.35 | 12.53 | 14.99 |
| | 1.5 | 41.23 | 51.25 | 53.74 | 49.19 | 53.45 | 58.06 | 15.67 | 17.71 | 20.44 |
| | 2 | 44.95 | 56.97 | 58.15 | 51.98 | 58.68 | 63.57 | 21.80 | 23.30 | 25.61 |
| | 3 | 48.09 | 62.98 | 66.42 | 57.35 | 65.61 | 73.19 | 28.07 | 29.43 | 31.06 |

B. Using Alg-Aam-SI Composite Hydrogel

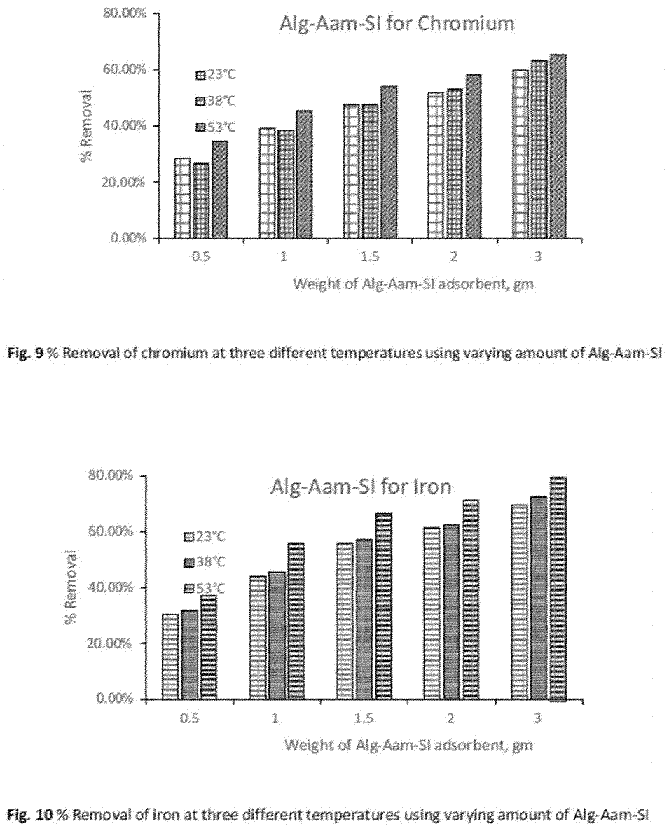

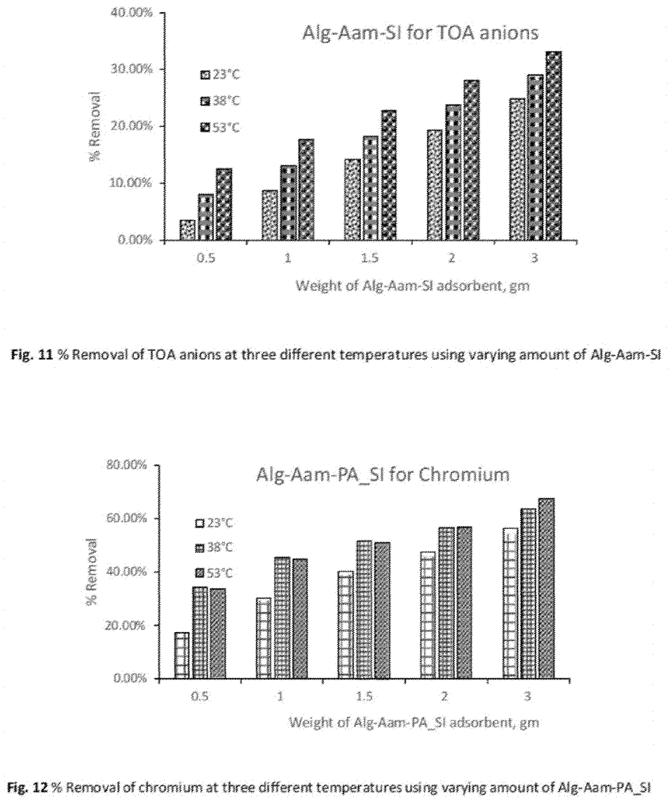

The % removal of chromium, iron and TOA anions using Alg-Aam-SI composite hydrogel for five different weights are shown in Table 2 and FIG. 9-11.

TABLE 2
% Removal of chromium, iron and TOA anions at three different temperatures
using varying amount of Alg-Aam-SI composite hydrogel.

| | | % Removal of Chromium | | | % Removal of Iron | | | % Removal of TOA anions | | |
|---|---|---|---|---|---|---|---|---|---|---|
| Adsorbent | Wt., gm | 23° C. | 38° C. | 53° C. | 23° C. | 38° C. | 53° C. | 23° C. | 38° C. | 53° C. |
| Alg-Aam-SI | 0.5 | 28.60 | 26.78 | 34.56 | 30.35 | 31.78 | 37.15 | 3.41 | 8.04 | 12.53 |
| | 1 | 39.04 | 38.46 | 45.42 | 44.03 | 45.34 | 56.04 | 8.72 | 13.08 | 17.71 |
| | 1.5 | 47.63 | 47.66 | 54.11 | 55.92 | 57.10 | 66.46 | 14.17 | 18.26 | 22.75 |
| | 2 | 51.95 | 53.03 | 58.12 | 61.44 | 62.39 | 71.38 | 19.35 | 23.84 | 28.07 |
| | 3 | 59.86 | 63.35 | 65.38 | 69.65 | 72.66 | 80.80 | 24.80 | 29.02 | 33.11 |

C. Using Alg-Aam-PA_SI Composite Hydrogel

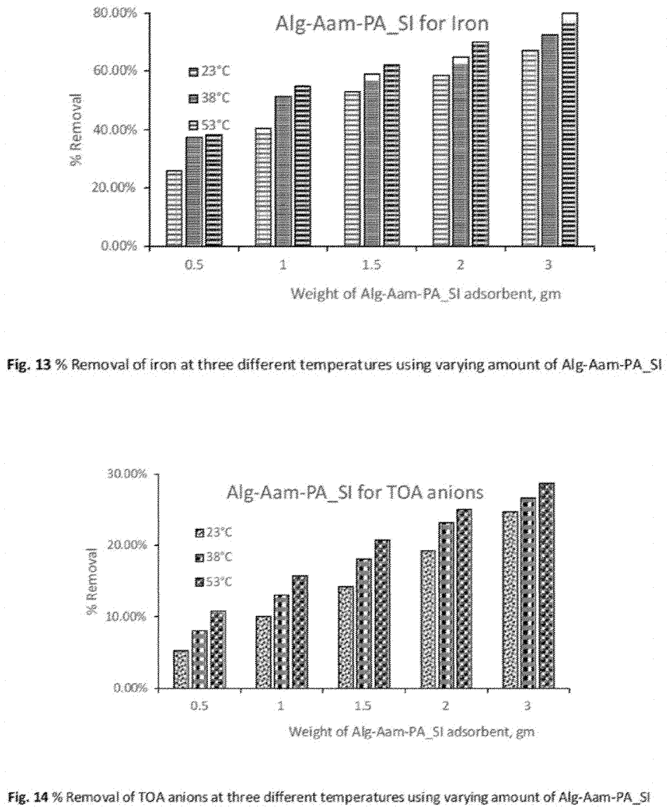

The % removal of chromium, iron and total organic acid anions using Alg-Aam-PA_SI composite hydrogel for five different weights are shown in Table 3 and FIG. 12-14.

TABLE 3
% Removal of chromium, iron and TOA anions at three different temperatures
using varying amount of Alg-Aam-PA_SI composite hydrogel.

| | | % Removal of Chromium | | | % Removal of Iron | | | % Removal of TOA anions | | |
|---|---|---|---|---|---|---|---|---|---|---|
| Adsorbent | Wt., gm | 23° C. | 38° C. | 53° C. | 23° C. | 38° C. | 53° C. | 23° C. | 38° C. | 53° C. |
| Alg-Aam-PA_SI | 0.5 | 17.43 | 34.22 | 33.61 | 25.85 | 37.08 | 38.14 | 5.31 | 8.04 | 10.76 |
| | 1 | 30.22 | 45.48 | 44.87 | 40.47 | 51.41 | 54.88 | 10.08 | 13.08 | 15.80 |
| | 1.5 | 40.34 | 51.58 | 50.97 | 52.96 | 58.83 | 62.20 | 14.31 | 18.12 | 20.84 |
| | 2 | 47.47 | 56.51 | 56.92 | 58.62 | 64.77 | 69.89 | 19.35 | 23.30 | 25.07 |
| | 3 | 56.36 | 63.63 | 67.56 | 67.24 | 72.42 | 79.99 | 24.80 | 26.70 | 28.75 |

D. Using Alg-Aam-GO Composite Hydrogel

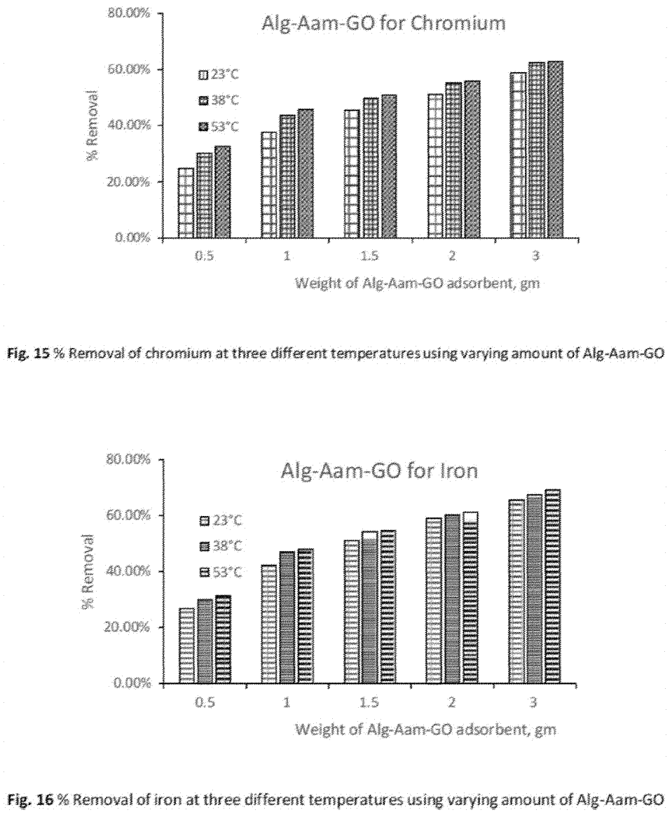

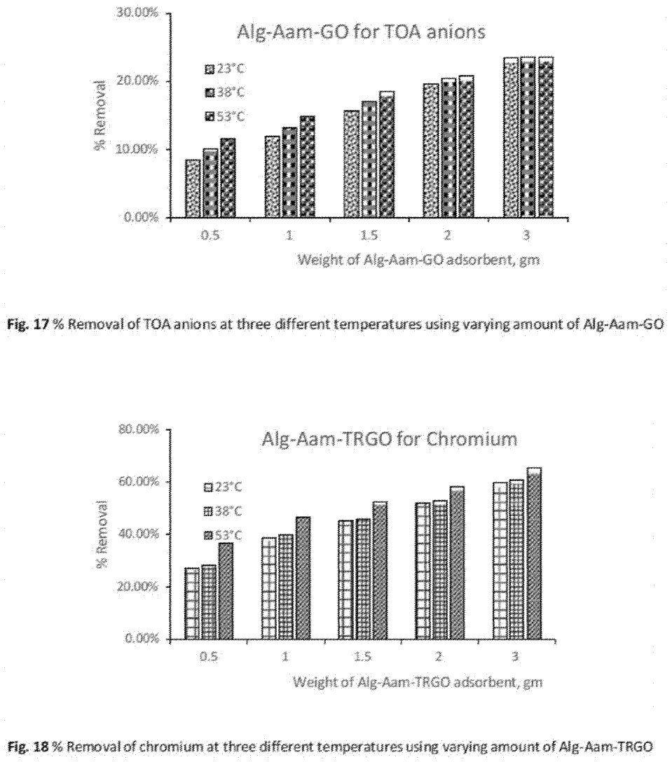

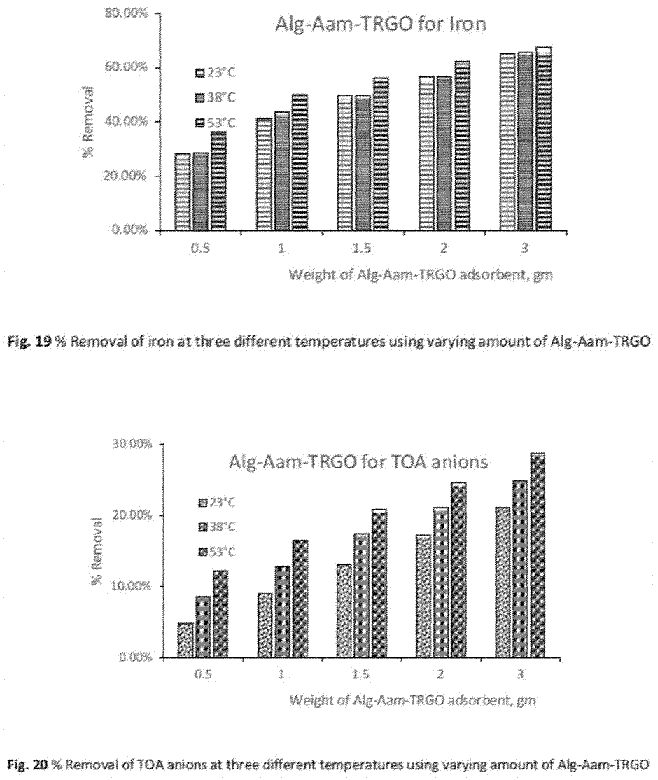

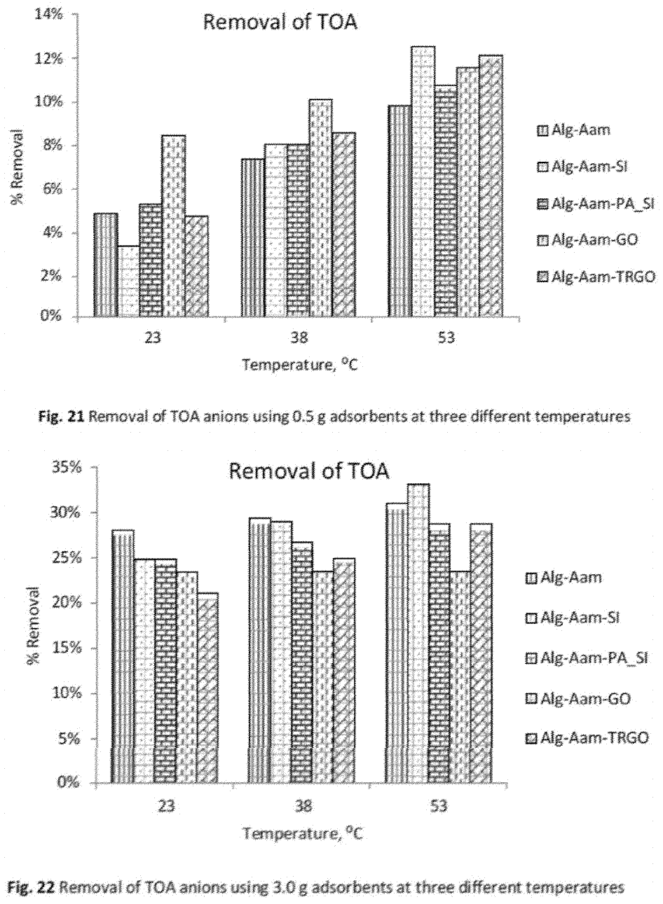

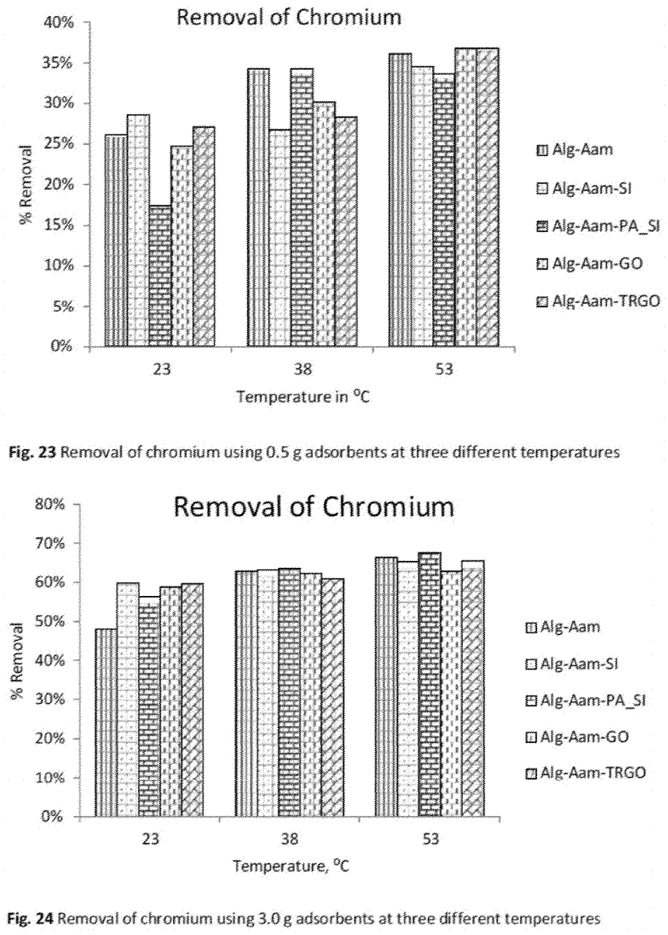

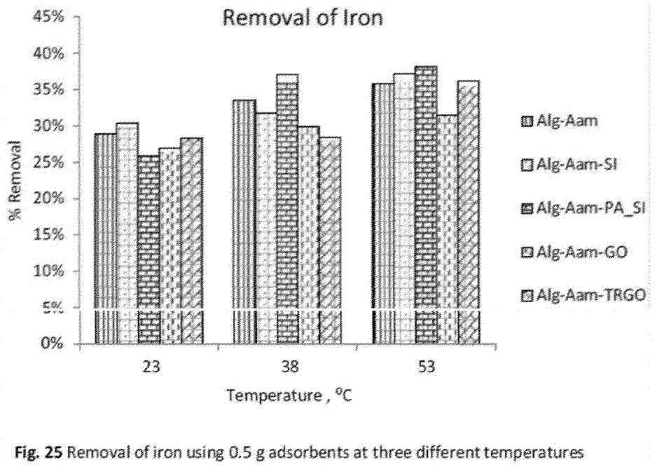

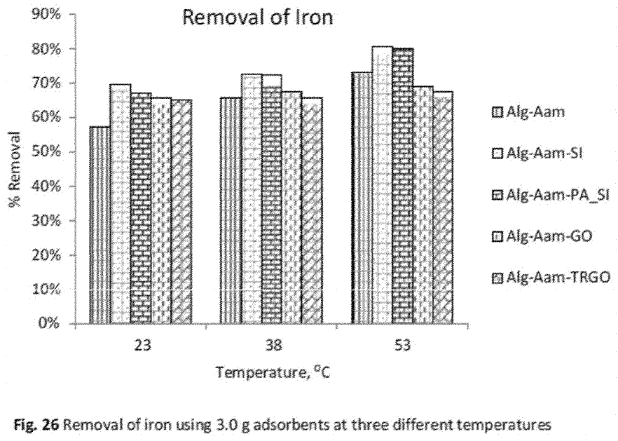

The % removal of chromium, iron and total organic acid anions using Alg-Aam-GO composite hydrogel for five different weights are shown in Table 4 and FIG. 15-17.

TABLE 4
% Removal of chromium, iron and TOA anions at three different temperatures
using varying amount of Alg-Aam-GO composite hydrogel.

| | | % Removal of Chromium | | | % Removal of Iron | | | % Removal of TOA anions | | |
|---|---|---|---|---|---|---|---|---|---|---|
| Adsorbent | Wt., gm | 23° C. | 38° C. | 53° C. | 23° C. | 38° C. | 53° C. | 23° C. | 38° C. | 53° C. |
| Alg-Aam-GO | 0.5 | 24.78 | 30.20 | 32.74 | 26.91 | 29.92 | 31.45 | 8.45 | 10.08 | 11.58 |
| | 1 | 37.63 | 43.74 | 45.74 | 42.08 | 47.10 | 48.04 | 11.85 | 13.22 | 14.85 |
| | 1.5 | 45.64 | 49.89 | 50.88 | 51.14 | 54.31 | 54.63 | 15.67 | 17.03 | 18.53 |
| | 2 | 51.28 | 55.18 | 55.87 | 58.89 | 60.25 | 61.28 | 19.62 | 20.44 | 20.84 |
| | 3 | 58.82 | 62.39 | 62.91 | 65.76 | 67.47 | 69.15 | 23.43 | 23.57 | 23.57 |

The batch adsorption studies using different composite hydrogels were used as adsorbent (Alg-Aam, Alg-Aam-SI, Alg-Aam-PA_SI, Alg-Aam-TRGO, Alg-Aam-GO) to remove both organic acid anions and heavy metal ions like chromium and iron from industrial lean MDEA solvent at different temperatures (23° C.-53° C.). The equilibrium adsorption studies were conducted with different weight of each composite hydrogel. Alg-Aam-SI composite adsorbent was best among others to remove maximum total organic acid anions (33.11%) and iron (80.8%) at 53° C. using 3.0 gm. While, removal of chromium was comparable with other adsorbents.

Each of the limitations of the invention can encompass various embodiments of the invention. It is, therefore, anticipated that each of the limitations of the invention involving any one element or combinations of elements can be included in each aspect of the invention. This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

Although illustrative embodiments of the invention has been shown and described, it is to be understood that various modifications and substitutions may be made by those skilled in the art without departing from the novel spirit and scope of the invention.

1. A calcium alginate-polyacrylamide-X composite hydrogel, wherein X is selected from one of the following compounds: silica, polyaniline-silica, graphene oxide, and reduced graphene oxide.

2. The composite hydrogel according to claim 1 wherein X is silica.

3. The composite hydrogel according to claim 1 wherein X is polyaniline-silica.

4. The composite hydrogel according to claim 1 wherein X is graphene oxide.

5. The composite hydrogel according to claim 1 wherein X is reduced graphene oxide.

6. The composite hydrogel according to claim 1 wherein the hydrogels are prepared by solution polymerization.

7. A method for regenerating a methyldiethanolamine solution in which a methyldiethanolamine solution is passed through a hydrogel according to claim 1.

8. The method according to claim 7 in which organic acid anions and/or heavy metal ions are removed from the methyldiethanolamine solution.

9. The method according to claim 8 wherein the heavy metal ions comprise chromium and/or iron.

10. The method according to claim 7 wherein the methyldiethanolamine is previously used to scrub H₂S/CO₂.
